(19) United States
(12) Patent Application Publication
(10) Pub. No.: US 2003/0158952 A1
(43) Pub. Date: Aug. 21, 2003

(54) Method and apparatus for associating virtual communications ports with applications and services on bluetooth enabled devices

(76) Inventors: Kris Fleming, Chandler, AZ (US); Uma Gadamsetty, Chandler, AZ (US)

Correspondence Address: Glenn E. Von Tersch, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/752,643

(22) Filed: Dec. 29, 2000

(51) Int. Cl. G06F 15/16

(52) U.S. Cl. 709/230

(57) ABSTRACT

A method and apparatus for associating virtual communications ports with applications and services on bluetooth enabled devices is presented. In one embodiment, the invention is a method. The method includes sending a query. The method also includes aeceiving a response including a set of records of available services, each record of the set including a service name and a service virtual communication port.

### BACKGROUND OF THE INVENTION

1. Field of the Invention

The invention generally relates to communications between interconnected devices and more specifically relates to service discovery and connection utilizing the Bluetooth protocol.

2. Description of the Related Art

Interconnecting devices has always required that the devices have a common method of communication. That has typically meant that two interconnected devices must use the same interconnecting wires for the same purposes, thus avoiding potentially damaging conflicts on the interconnection. As protocols for interconnection become more complicated, the simple direct connection may be abstracted in various manners by the various interconnected devices.

Abstracting interconnection protocols may simplify some aspects of a system, but it still remains important to determine the capabilities of various interconnected devices. With primitive protocols, the nature of the connection may imply the capabilities of the device, such as a monitor being connected to a video port implying capabilities related to displaying video images. Connecting a device to a more general purpose interconnection need not imply the capabilities of the device.

### BRIEF DESCRIPTION OF THE DRAWINGS

The present invention is illustrated by way of example and not limitation in the accompanying figures.

FIG. 1 illustrates an embodiment of a protocol for determining available services from a device.

FIG. 2 illustrates an embodiment of a service record which may be provided by an advertising device.

FIG. 3 illustrates an embodiment of a process of advertising a service.

FIG. 4 illustrates an embodiment of a process of inquiring about services.

FIG. 5 illustrates an embodiment of a medium.

FIG. 6 illustrates an embodiment of a system.

FIG. 7A illustrates an embodiment of a set of interconnected devices.

FIG. 7B illustrates an alternate embodiment of a set of interconnected devices.

### DETAILED DESCRIPTION

A method and apparatus for associating virtual communications ports with applications and services on bluetooth enabled devices is described. In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments.

Utilizing the Bluetooth protocol, devices may be connected through a wireless interconnection, allowing for great flexibility in the types of devices which may be interconnected and the types of information which may be transferred. However, this flexibility requires a method of determining what devices are connected and what capabilities the connected devices have. In one embodiment, an SDP (Service Discovery Protocol) query is sent from a first device to a second device, and the second device responds by advertising the services of the second device. While this method need not be limited to the Bluetooth protocol, it is well suited to the flexible nature of the Bluetooth protocol. Moreover, it will be appreciated that a number of different implementations of an SDP query and response may be utilized within the spirit and scope of the invention.

In one implementation of the Bluetooth protocol, services on a device are made available for connection with other devices over the Bluetooth virtual bus. Each service is assigned a virtual communications port, which may be modeled on the COM Ports well known for PC™ style computers. However, keeping track of virtual communications ports assigned to specific services may be difficult. Additionally, such virtual communication port assignments may change over time for a variety of reasons, such as devices disengaging or engaging with the Bluetooth virtual bus or devices undergoing internal reconfiguration.

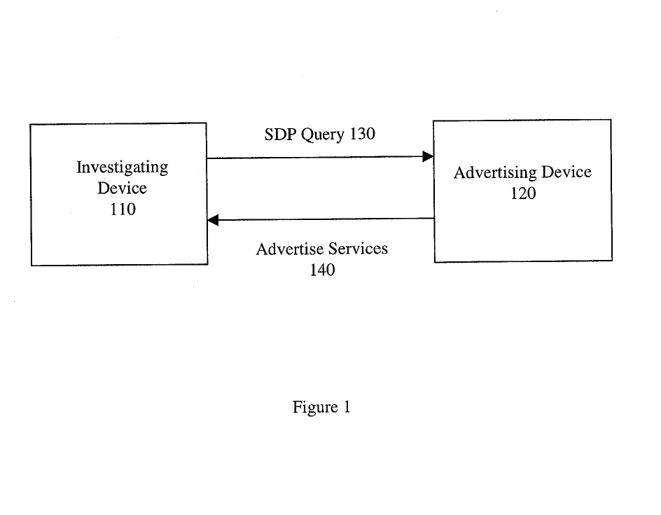

FIG. 1 illustrates an embodiment of a protocol for determining available services from a device. An investigating device 110 sends an SDP query 130 to an advertising device 120, requesting information about the capabilities of the advertising device 120. The advertising device 120 sends back an SDP response 140 which advertises the services available from the advertising device 120. The Bluetooth protocol typically uses virtual communications ports for purposes of communication between devices, but keeping track of which port corresponds to a given service on a given device may be difficult.

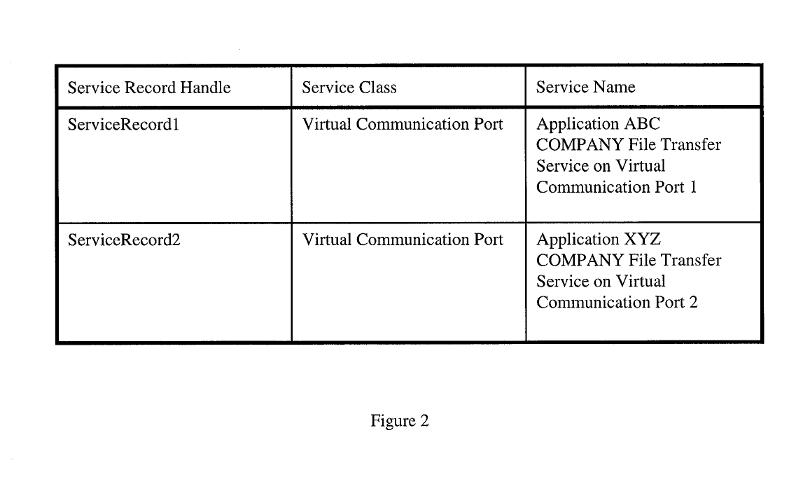

FIG. 2 illustrates an embodiment of a service record which may be provided by an advertising device. Each service record has a service record handle, such as ServiceRecord1 or ServiceRecord2 for example. Associated with each service record is a service class, which for each of these records is a virtual communications port. Also associated with each service record is a service name, which may be used to refer to the service. Thus, the service name rather the port may be used to connect to the service in question.

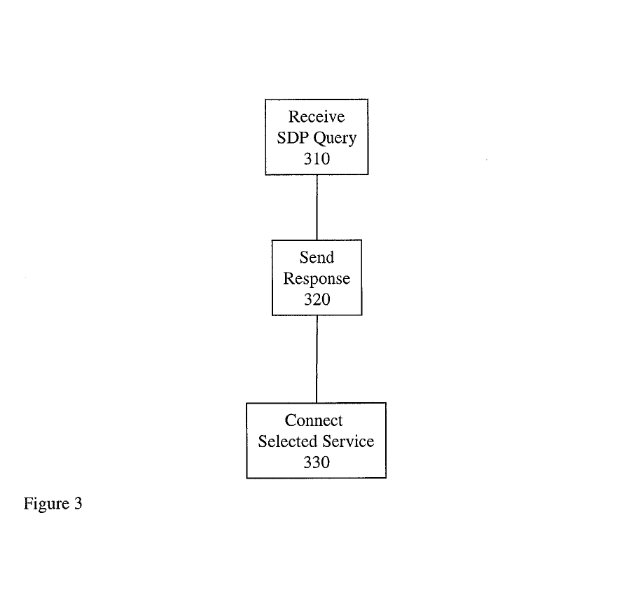

FIG. 3 illustrates an embodiment of a process of advertising a service. At block 310, an SDP query is received. At block 320, a response is sent, including information about the services available in a format such as the format illustrated in FIG. 2. At block 330, a service connection request is received and the appropriate service is connected. Note that connecting the service implies receiving some form of request to connect to the appropriate service. In one embodiment, the name of the service may be used as part of the service request for purposes of locating the appropriate service. For example, utilizing the illustration of FIG. 2, the name ‘Application ABC COMPANY file transfer service’ may be used to indicate the appropriate service. This avoids the problem of discovering and maintaining current information about which virtual communications port is utilized by a given service. Since the virtual communications ports are subject to change for various reasons, providing the ability to address by name may be advantageous. It will be appreciated that in one embodiment, the advertising process of FIG. 3 may be implemented by the advertising device 120 of FIG. 1.

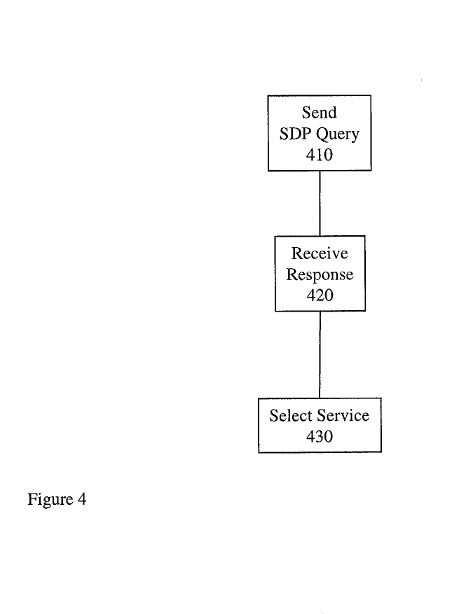

FIG. 4 illustrates an embodiment of a process of inquiring about services. At block 410, an SDP query is sent. At block 420, a response to the SDP query is received, including information about the services available in a format such as the format illustrated in FIG. 2. At block 430, a service from the services available is selected for connection, and a connection is initiated with the service. Initiating such a connection may include sending a connection request and having the connection completed by whatever sent the response. In one embodiment, the connection request need not include the virtual communication port identifier from the service, but need only include the name of the service. For example, utilizing the illustration of FIG. 2, the name ‘Application XYZ COMPANY file transfer service’ may be used to indicate the appropriate service. This avoids the problem of maintaining and discovering current information about the virtual communication port used by the service. As will be appreciated, in one embodiment, the process of FIG. 4 may be implemented by the investigating device 110 of FIG. 1.

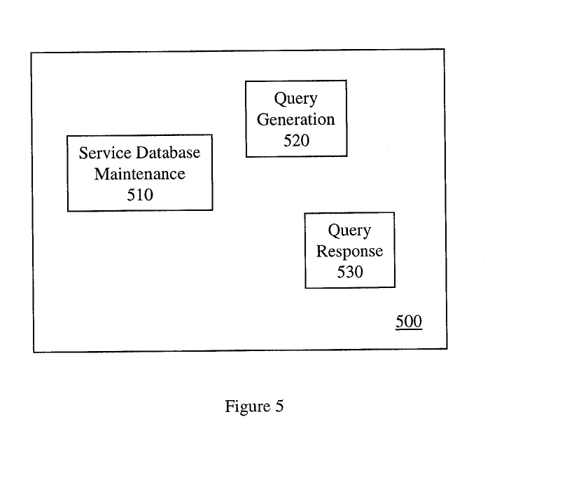

FIG. 5 illustrates an embodiment of a machine-readable medium. The machine-readable medium may include one or more of, but is not limited to, floppy diskettes, optical disks, CD-ROMs, and magneto-optical disks, ROMs, RAMs, EPROMs, EEPROMs, magnet or optical cards, flash memory, transmissive media, or other type of media/machine-readable medium suitable for storing electronic instructions. The medium may embody instructions or logic blocks, the logic blocks may be implemented as instructions or as some form of hard-wired logic for example. The instructions, when executed by a processor, cause the processor to perform a method dictated by the instructions.

The medium 500, in one embodiment, includes a service maintenance database block 510, a query generation block 520, and a query response block 530. It will be appreciated that other blocks may be added to medium 500 and that blocks in medium 500 may be subdivided or combined within the spirit and scope of the invention. In one embodiment, service maintenance database block 510 can be used to maintain a database indicating which services are available and how to connect to the service (such as what name to use). Such a database, in some embodiment, does not allow for deletion of services, only updating and potentially invalidation of services. By allowing for tracking of services by name rather than by virtual communication port, updating is kept to a minimum, and deletion is not as desirable, since the service may merely be invalidated if not useful, and multiple entries corresponding to different virtual communication ports are less likely to occur. Query generation block 520 and query response block 530, in one embodiment, implement generation of SDP queries and response to SDP queries, using the format of FIG. 2 for responses. It will be appreciated that other embodiments may implement the blocks of medium 500 in different ways within the spirit and scope of the invention.

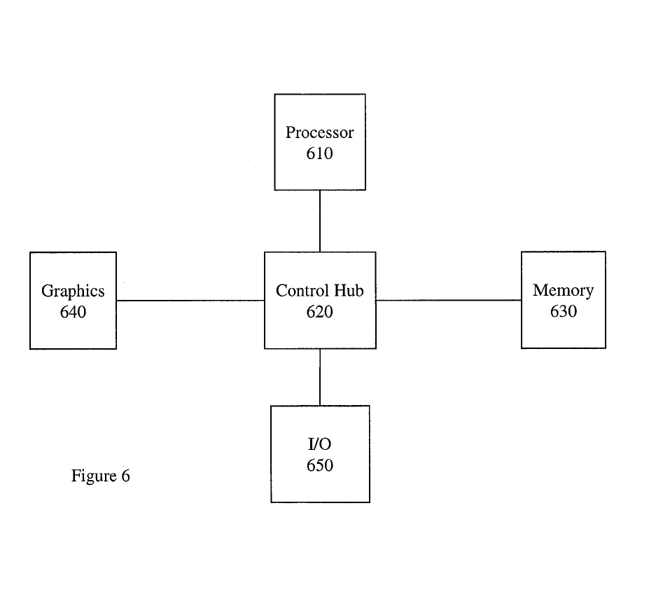

FIG. 6 illustrates an embodiment of a system. Processor 610 is coupled to control hub 620. Control hub 620, in turn, is coupled to each of memory 630, graphics block 640 and I/O interface 650. In one embodiment, I/O interface 650 includes a Bluetooth protocol interface, which may include a radio-frequency transceiver and modem circuitry among other components. As a result, the system including the processor 610, control hub 620 and I/O interface 650, in one embodiment, may be used to communicate with other devices using the Bluetooth protocol. Such communication may include the querying for and advertising of services as described previously, and may also include connecting to and utilizing such services. Moreover, the methods and apparatuses described previously may be incorporated into the system to achieve communication without a need to supply virtual communication ports when connecting to services on Bluetooth enabled devices.

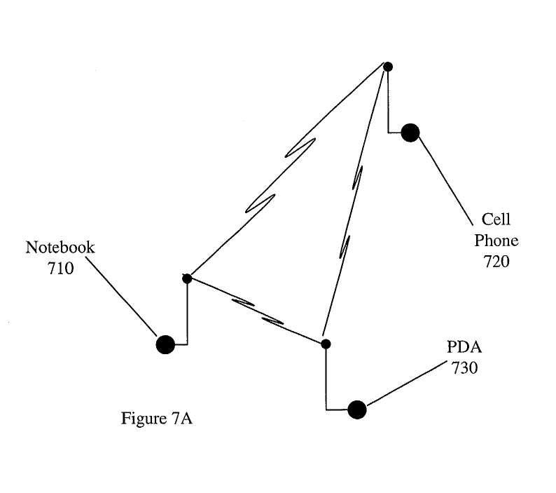

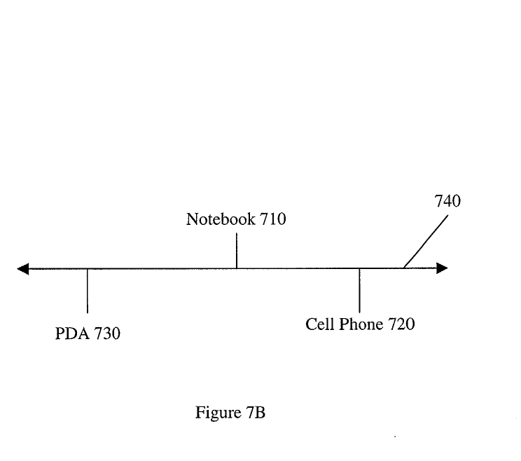

FIG. 7A illustrates an embodiment of a set of interconnected devices. Such an embodiment may represent the interconnections achieved using the Bluetooth radio frequency protocol. As illustrated, notebook 710 is coupled to cell phone 720 and PDA 730, all of which are Bluetooth enabled devices. Any of the three devices may query about services or advertise services, consistent with the internal capabilities of the devices. FIG. 7B illustrates an alternate embodiment of a set of interconnected devices. Bluetooth virtual bus 740 is illustrated as coupling notebook 710, cell phone 720 and PDA 730. Thus, the coupling illustrated in FIG. 7A may, in one embodiment, be modeled by the coupling or interconnection illustrated in FIG. 7B.

In the foregoing detailed description, the method and apparatus of the present invention has been described with reference to specific exemplary embodiments thereof. It will, however, be evident that various modifications and changes may be made thereto without departing from the broader spirit and scope of the present invention. In particular, the separate blocks of the various block diagrams represent functional blocks of methods or apparatuses and are not necessarily indicative of physical or logical separations or of an order of operation inherent in the spirit and scope of the present invention. For example, the various blocks of FIG. 6 may be integrated into components, or may be subdivided into components. Moreover, the blocks of FIGS. 3 and 4 for example, represent portions of a method which, in some embodiments, may be reordered or may be organized in parallel rather than in a linear or step-wise fashion. The present specification and figures are accordingly to be regarded as illustrative rather than restrictive.

What is claimed is:

1. A method comprising:
Sending a query; and
Receiving a response including a set of records of available services, each record of the set including a service name and a service virtual communication port.

2. The method of claim 1 further comprising:
Connecting to each service for which a record exists in the set of records.

3. The method of claim 1 wherein:
The query is sent utilizing a Bluetooth protocol SDP request and the response is received in the form of an SDP response.

4. The method of claim 1 further comprising:
Connecting to a first service for which a record exists in the set of records utilizing the service name of the first service to initiate connection.

5. The method of claim 1 further comprising:
Connecting to a second service for which a record exists in the set of records utilizing the service name of the second service to initiate connection.

6. The method of claim 5 wherein:
The query is sent utilizing a Bluetooth protocol SDP request and the response is received in the form of an SDP response.

7. An apparatus comprising:
means for sending a query; and
means for receiving a response including a set of records of available services, each record of the set including a service name and a service virtual communication port.

8. The apparatus of claim 7 wherein:
the means for sending a query utilizes a Bluetooth protocol SDP request as the query; and
the means for receiving a response is configured to receive a Bluetooth protocol SDP response.

9. The apparatus of claim 8 further comprising:
means for connecting to each service for which a record exists in the set of records.

10. A system comprising:
a processor;
a control hub coupled to the processor;
an I/O interface coupled to the control hub;
wherein: the processor, control hub, and I/O interface are collectively configured to:
Send a query; and
Receive a response including a set of records of available services, each record of the set including a service name and a service virtual communication port.

11. The system of claim 10 wherein:
the I/O interface includes a Bluetooth interface.

12. The system of claim 11 wherein:
the processor, control hub, and I/O interface are further configured to:
Connect to each service for which a record exists in the set of records.

13. A machine-readable medium embodying instructions, the instructions, when executed by a processor, causing the processor to perform a method, the method comprising:
Sending a query; and
Receiving a response including a set of records of available services, each record of the set including a service name and a service virtual communication port.

14. The machine-readable medium of claim 13 further embodying instructions, the instructions, when executed by a processor, causing the processor to perform a method wherein:
The query is sent utilizing a Bluetooth protocol SDP request and the response is received in the form of an SDP response.

15. The machine-readable medium of claim 14 further embodying instructions, the instructions, when executed by a processor, causing the processor to perform a method further comprising:
Connecting to a first service for which a record exists in the set of records utilizing the service name of the first service to initiate connection; and
Connecting to a second service for which a record exists in the set of records utilizing the service name of the second service to initiate connection.

16. A method comprising:
Receiving a query;
Sending a response to the query, the response including a set of records of available services, each record of the set including a service name and a virtual communication port.

17. The method of claim 16 wherein:
The query is received as a Bluetooth protocol SDP request and the response is sent as an SDP response.

18. The method further comprising:
Connecting a first service of the available services to a remote device based on a service name of the first service supplied by the remote device.

19. The method further comprising:
Connecting a second service of the available services to a remote device based on a service name of the second service supplied by the remote device.

20. An apparatus comprising:
means for receiving a query; and
means for sending a response to the query, the response including a set of records of available services, each record of the set including a service name and a virtual communication port.

21. The apparatus of claim 20 wherein:
The query is received as a Bluetooth protocol SDP request and the response is sent as an SDP response.

22. The apparatus of claim 21 further comprising:
means for connecting a service of the available services to a remote device based on a service name of the service supplied by the remote device.

23. A system comprising:
a processor;
a control hub coupled to the processor;
an I/O interface coupled to the control hub;
wherein: the processor, control hub, and I/O interface are collectively configured to:
Receive a query; and
Send a response to the query, the response including a set of records of available services, each record of the set including a service name and a virtual communication port.

24. The system of claim 23 wherein:
the I/O interface includes a Bluetooth interface; and
The query is received as a Bluetooth protocol SDP request and the response is sent as an SDP response.

25. The system of claim 24 wherein the processor, control hub, and I/O interface are further configured to connect a service of the available services to a remote device based on a service name of the service supplied by the remote device.

26. A machine-readable medium embodying instructions, the instructions, when executed by a processor, causing the processor to perform a method, the method comprising:
Receiving a query;
Sending a response to the query, the response including a set of records of available services, each record of the set including a service name and a virtual communication port.

27. The machine-readable medium of claim 26 further embodying instructions, the instructions, when executed by a processor, causing the processor to perform a method wherein:
The query is received as a Bluetooth protocol SDP request and the response is sent as an SDP response.

28. The machine-readable medium of claim 27 further embodying instructions, the instructions, when executed by a processor, causing the processor to perform a method further comprising:
Connecting a first service of the available services to a remote device based on a service name of the first service supplied by the remote device.

29. The machine-readable medium of claim 28 further embodying instructions, the instructions, when executed by a processor, causing the processor to perform a method further comprising:
Connecting a first service of the available services to a remote device based on a service name of the first service supplied by the remote device.
